(19) United States
(12) Patent Application Publication
(10) Pub. No.: US 2008/0133554 A1
(43) Pub. Date: Jun. 5, 2008

(54) Method for Storing Multipurpose Geographic Information

(75) Inventors: Chung-Ho Lee, Daejon (KR); Jaehong Oh, Daejon (KR); Hong-Gab Kim, Gyeonggi-do (KR); Ki-In Bang, Gyeonggi-do (KR); Chang-Rak Yoon, Daejon (KR); Young-Jae Lim, Jeollabuk-do (KR); Kyung-Ok Kim, Daejon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institue, Daejon (KR)

(21) Appl. No.: 11/791,587

(22) PCT Filed: Dec. 30, 2004
(86) PCT No.: PCT/KR2004/003533

§ 371 Date: May 23, 2007

(30) Foreign Application Priority Data
Nov. 26, 2004 (KR) 10-2004-0098214

(51) Int. Cl. G06F 17/30; G06F 19/00

(52) U.S. Cl. 707/100; 702/5; 707/E17.018

(57) ABSTRACT

Provided is a method for storing multipurpose geographic information, capable of integrating, storing, managing and using vector data (numerical map) and image, digital elevation model (DEM), three-dimensional (3D) point cloud data, and facility texture information. The method for storing multipurpose geographic information in a computing system includes the steps of: dividing geographic information data to be stored into minimum units; classifying the divided geographic information data into geometric information (geographic position information) and attribute information; and storing the geometric information (geographic position information) in a vector format and storing the attribute information in an attribute information linked to a vector.

### TECHNICAL FIELD

The present invention relates to a method for storing a multipurpose geographic information; and, more particularly, to a method for storing a multipurpose geographic information, capable of integrating, storing, managing and using vector data (numerical map) and image, digital elevation model (DEM), three-dimensional (3D) point cloud data, and facility texture information.

### BACKGROUND ART

In the geographic information fields, numerical map and image, digital elevation model (DEM), and point cloud are widely used to provide a user with geometrical contents or spectroscopic data representing land or recognizable landmark.

Images acquired from airplane or satellite are called Raster data, and data having grid-shaped pixel as minimum unit are arranged. Color or spectroscopic information representing the captured object is assigned to each pixel in the form of digital value. These pixels are displayed on a screen such that the user recognizes and uses the image.

Vector data such as the numerical map records the recognizable landmark, which is represented on the image or land, using geometrical expression such as points, lines, polygons, circles, and arcs. They are stored in a computer according to a predetermined protocol. These vector data are displayed on a screen in a form of a map that the user can recognize.

The DEM is data representing topography of the land surface and has a regular grid such as an image. While the image has a color or spectroscopic information recorded on pixels, the DEM has height value of the land surface.

Like the DEM, the point clouds are altitude information representing topology of the land surface. However, the point clouds are recorded in a set of irregular points, not in regular grid form.

FIGS. 1 to 5 are pictures illustrating samples of various data samples.

As described in the above, various kinds of data and the various kinds of data formats used in the geographic information field have a meaning and advantage in one's own way. The element which was impeded when data of the single tone was used was not discovered. However, the desire of the users for using of various data in various ways does not reach the step of integrating or combining two or more data, so that data formats accommodating an existing single kind of data acts on disadvantage that is unable to be highlighted in data integration side. Therefore, if data are physically integrated through one format, the storing and managing method can be simplified and different kinds of data can be more easily integrated and combined in an application software.

A first prior art related to the present invention is disclosed in Korean Patent Laid-open Publication No. 2002-0025855, published on Apr. 4, 2002, entitled “STORAGE SYSTEM AND METHOD OF A SIMPLE ELECTRON MAP”. While the first prior art minimizes storage space of vector data, the present invention mixes and stores vector data and different data.

For this purpose, the first prior art minimizes the storage space through a coordinate conversion. On the contrary, the present invention can efficiently store and manage various data by mixing and storing various data (image, DEM, point clouds, texture data, etc.) and vector data (numerical map) through an expansion of dxf vector format.

Meanwhile, a second prior art is disclosed in a paper entitled “EFFICIENT SPACE DATA COLLECTION IN GEOGRAPHIC DATABASE SYSTEM” (Korean Information processing association, Paper A, Vol. 1-3, pp. 279-289, September 1994). While the second prior art vectorizes vector data and efficiently stores the vector data, the present invention mixes and stores vector data and different data.

The second prior art can minimizes storage space through compression using tag bit, thereby efficiently using the storage space. On the contrary, the present invention can efficiently store and manage various data by mixing and storing various data (image, DEM, point clouds, texture data, etc.) and vector data (numerical map) through an expansion of dxf vector format.

Like this, the image, numerical map, DEM, point clouds, and texture information are the important data that are widely used in geographic information and remote exploration fields. A process of overlappingly displaying and integrating the data is often necessary. However, these data are frequently used at the same time, but the characteristic of the data is different.

That is, the image includes data of minimum data, called pixel, at regular grid intervals. Digital value representing a color is assigned and stored in each pixel. Also, in vector data such as numerical map, geometric characteristics are recorded in a file in a form of point, line, polygon, circle, and arc. An attribute of each shape may be stored together. Further, the DEM and the point clouds are similar in view of recording 3D point. However, the DEM is a regular grid data, while the point clouds are a set of irregular points. Moreover, the texture information is a kind of image piece. However, unlike the general image, the texture information may not be expressed in a rectangular shape in an entire shape.

In these different characteristics, each data is stored and managed in a different format, and the role and advantage exist in each data. However, when the mixed two or more data are used, they are physically divided and then stored and managed. For these reasons, the use is difficult and inconvenient.

Accordingly, there is an increasing demand for a method of integrating data of different characteristics, and managing and using the integrated data.

### DISCLOSURE

### Technical Problem

It is, therefore, an object of the present invention to provide a method for storing multipurpose geographic information, capable of integrating, storing, managing and using vector data (numerical map) and image, digital elevation model (DEM), three-dimensional (3D) point cloud data, and facility texture information.

### Technical Solution

In accordance with one aspect of the present invention, there is provided a method for storing multipurpose geographic information in a computing system, including the steps of: dividing geographic information data to be stored into minimum units; classifying the divided geographic information data into geometric information (geographic position information) and attribute information; and storing the geometric information (geographic position information) in a vector format and storing the attribute information in an attribute information linked to a vector.

Also, the present invention provides a method for integrating and storing various data formats in the same recording scheme.

The data integrating/managing method in accordance with the present invention expands the existing method of recording general vector data (numerical map) and can record image, DEM, and point clouds.

The data recording format is divided into a quantitative part and a qualitative part. The quantitative part represents information of geographic position and geometrical shape, and the qualitative part represents color of each vector object, kind of line, and filler color of polygon. Various kinds of data are supported by separately storing the data in the quantitative information and the qualitative information.

This data storing method can integratedly manage various data and can be used variously. For example, in the case of 3D space modeling that virtually embodies a real topography and city on a computer, texture information is required to express 3D vector data of the facility and the surface of the facility. At this point, these data can be integrated and stored.

### ADVANTAGEOUS EFFECTS

As described above, the present invention can provide convenience to the user by managing and using various kinds of closely associated geographic information, which is stored in the same format and same file, and managing and using it.

Also, the present invention can provide the easiness of modification/edit by storing the image and the DEM in a vector format.

Further, by providing the integrated storing method of vector information and texture information for 3D modeling, which has been impossible in the existing method, the 3D modeling can be processed more conveniently and promptly. The management becomes convenient due to the storing method in which the texture information is not divided.

### DESCRIPTION OF DRAWINGS

The above and other objects and features of the present invention will become apparent from the following description of the preferred embodiments given in conjunction with the accompanying drawings, in which:

FIGS. 1 to 5 are pictures illustrating samples of various data;

FIG. 6 is a block diagram of a hardware system in accordance with the present invention;

FIG. 7 is a flowchart illustrating a method for storing a multipurpose geographic information in accordance with the present invention;

FIG. 8 is a diagram illustrating a process of dividing an image into a vector and an attribute in the method for storing the multipurpose geographic information in accordance with the present invention;

FIG. 9 is a flowchart illustrating a process of storing an image in a vector form in the method for storing the multipurpose geographic information in accordance with the present invention;

FIG. 10 is a diagram illustrating a process of storing a polygonal texture in the method for storing the multipurpose geographic information in accordance with the present invention;

FIG. 11 is a flowchart illustrating a process of storing a polygonal texture in the method for storing the multipurpose geographic information in accordance with the present invention;

FIG. 12 is a diagram illustrating a DEM converted into a TIN in the method for storing the multipurpose geographic information in accordance with the present invention; and

FIG. 13 is a flowchart illustrating a process of storing a DEM in the method for storing the multipurpose geographic information in accordance with the present invention.

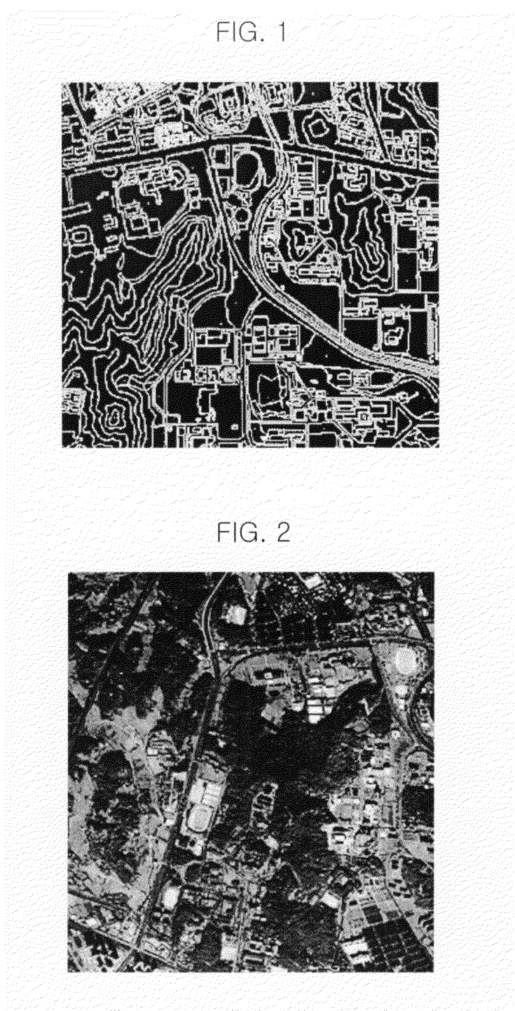

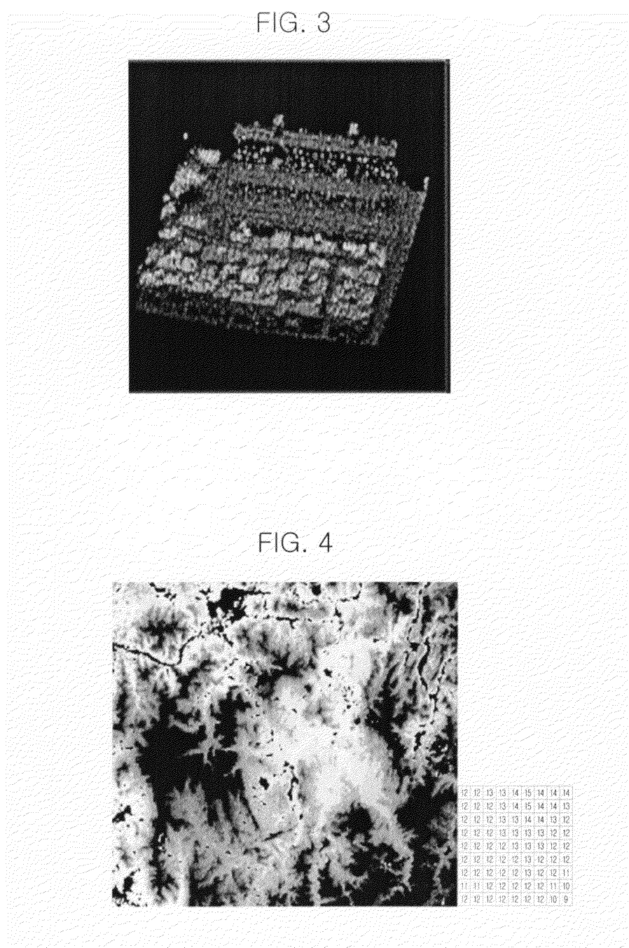

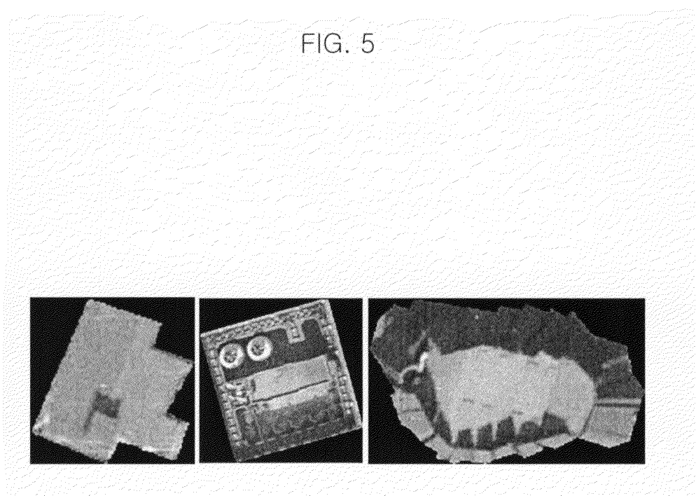

### BEST MODE FOR THE INVENTION

Other objects and aspects of the invention will become apparent from the following description of the embodiments with reference to the accompanying drawings, which is set forth hereinafter.

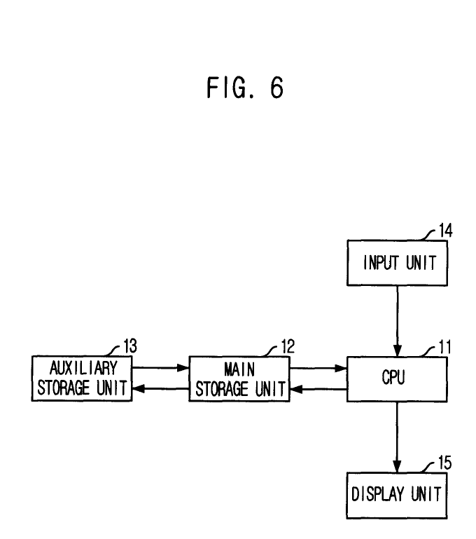

FIG. 6 is a block diagram of a hardware system in accordance with the present invention. In FIG. 6, reference numerals 11, 12, 13, 14 and 15 represent a central processing unit (CPU), a main storage unit, an auxiliary storage unit, an input unit, and a display unit, respectively.

Referring to FIG. 6, the hardware system (e.g., a geographic information database system) includes a CPU 11, a main storage unit 12 connected to the CPU 11, an auxiliary storage unit 13 connected to the main storage unit 12, and an input unit 14 and a display unit 15 connected to the CPU 11.

The CPU 11 controls and manages an overall operation of a computer. The main storage unit 12 and the auxiliary storage unit 13 store a program executed in the CPU 11 and stores various data used or generated during operations. The input/output units 14 and 15 input/output data from/to a user.

The auxiliary storage unit 13 stores a large capacity of data, and the input/output units 14 and 15 include a keyboard, a display unit, and a printer.

Since a computer hardware environment with the above-described structure is well known to those skilled in the art, a detailed description thereof will be omitted. Hereinafter, a process of integrating and storing vector data (numerical map) and image, DEM, 3D point cloud data, and a facility texture information will be described in detail.

In order to integrate and store vector data (numerical map), and image, DEM, 3D point cloud data, and facility texture information, various data are stored in the same format as follows. Examples of data that can be inputted are image, DEM, point clouds, numerical map (vector), and texture. At this time, a common storing method is based on a vector recording method such as an existing DXF. Contents that are not supported in the existing vector storing method are stored in a form of separate attribute data.

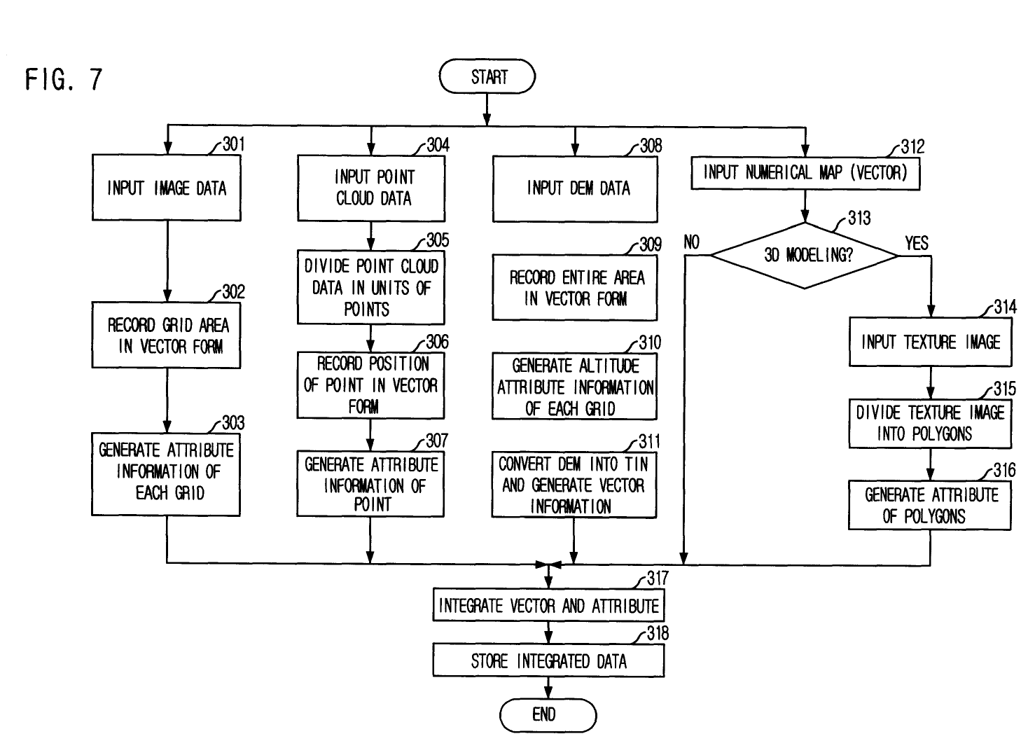

FIG. 7 is a flowchart illustrating a method for storing a multipurpose geographic information in accordance with the present invention. The integrated storage format uses an interface of attribute based on a vector format.

Referring to FIG. 7, data provided in various formats are divided into minimum units. The data include an image 301, a point cloud data 304, a DEM 308, a vector data 312 such as a numerical map, and a texture 314. The divided data are classified into geometric information and attribute information. The geometric information is stored in an existing vector format and the attribute information is stored as attribute information connected to the vector.

The storing method of the present invention is an expanded vector storing method and can easily convert data of vector format such as the numerical map. Also, if necessary, additional attribute information can be set. That is, it is possible to additionally record the attributes that are used to express the vectors (line width or color of line segment components representing each object of the vector, filler color in an inside of the polygon, and other geographic information) on the display unit. Also, when layer information and other information associated with vector object exist in the inputted source vector data, the information is also stored.

First, the process of storing the point cloud data in a vector format will be described.

The point clouds are a set of regular 3D points. Although a density of each point may be dense like an image, the point clouds are not data with regular arrangement. Accordingly, when the point cloud data are inputted (S304), they are divided in units of points (305). Information associated with 3D position is extracted from the point related information. Among the object formats of the vector, the point clouds are stored a point format (306). Colors are assigned in each section according to altitude and stored as an attribute of each point (307). Then, the vector and the attribute are integrated (317) and stored as an integrated data (318).

Meanwhile, the image is data with regular grid form, which is different from the vector, and does not have vector object.

Therefore, in order to store the image in the vector format, when the image data is inputted (301), the gird area is recorded in a vector format (302) and attribute information of each grid is generated (303). Then, the vector and the attribute are integrated (317) and stored as an integrated data.

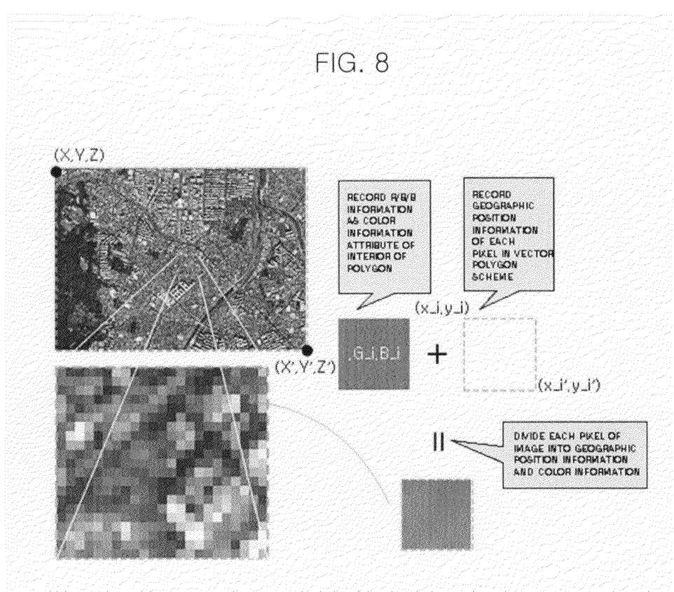

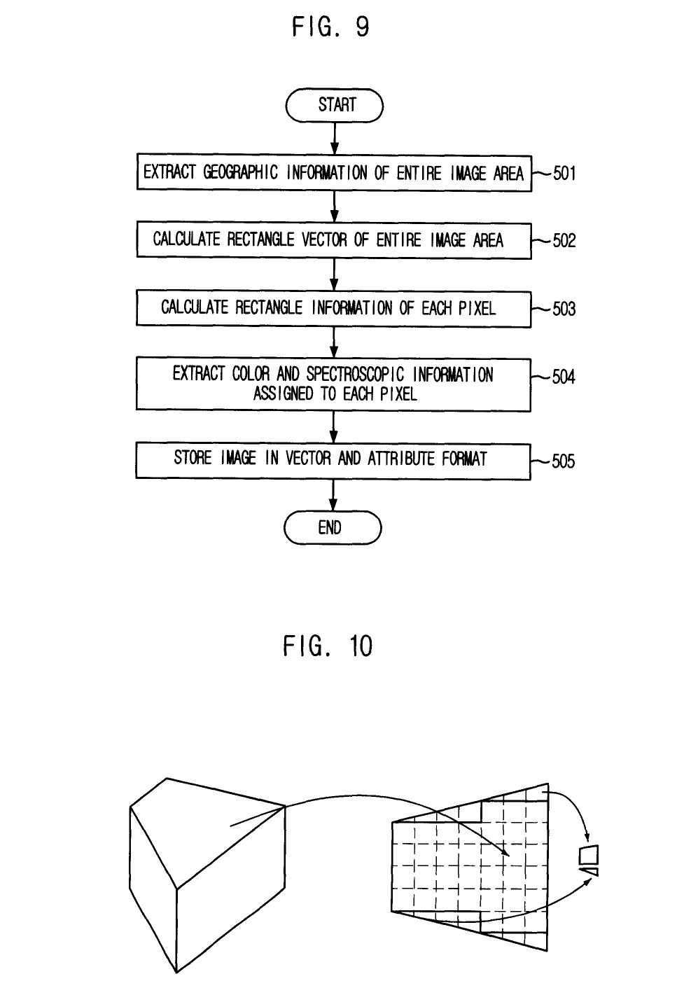

That is, as illustrated in FIG. 9, geographic information with respect to the rectangular area is extracted and the entire image is stored as a vector object (501-503). Pixel values of the rectangular area representing each pixel are stored as attribute (504, 505). The process of dividing the image into the vector and the attribute will be described below with respect to FIG. 8.

In FIG. 8, (X, Y, Z) and (X′, Y′, Z′) represent geographic coordinates of a left upper portion and a right lower portion of each image. When storing the information of each pixel, the entire image area must be set such that they can be recognized as squares with the same size. However, the setting of the internal squares as many as a total number of the entire pixels increases the storage capacity and obstructs the efficient use. Therefore, the simplification has to be performed using the characteristics of the image with regular grid form. That is, the squares are not directly defined as many as the rectangles of the entire image. Instead, the existence of the internal rectangle can be deduced by storing only the size or resolution of the image as the attribute. The color information or spectroscopic information stored in the pixels of each image is designated as filler color attribute of the rectangle. Therefore, the color or spectroscopic information contained in each pixel is stored in an image in a form of one or more digitalized numbers. The digitalized numbers are extracted and stored in a position where the attribute is stored according to the pixel arrangement order of the image. Therefore, the values to be allocated in the squares inside the image can be expressed. In this manner, the geographic position information of each pixel and the color or spectroscopic information of each pixel are stored and all conditions required for expressing the image are prepared.

Unlike the general image, in the case of 3D modeling, the texture information used to express the surface of the modeling object may not be expressed using only the rectangles. Therefore, the above-described image storing method is insufficient. Consequently, polygon concept as well as rectangle concept has to be introduced in order to store the texture image.

FIG. 10 illustrates a virtual facility with trapezoid top and bottom faces and the top face is shown in a texture image. As illustrated in FIG. 10, the texture information on the trapezoid top face has different shape, unlike a general image restricted to polygon.

In order to store the texture image in a vector format, when the texture image is inputted (314), the texture image is divided into polygons (315) and the attribute of the polygon is generated (316). The vector and the attribute are integrated (317) and stored as an integrated data (318).

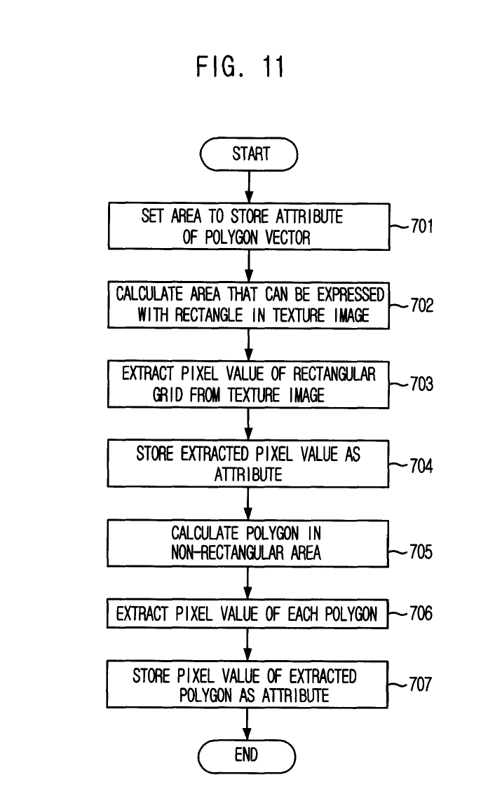

Referring to FIG. 11, in order to store the texture information with respect to the area defined in a polygonal shape, the method of recording the pixel of the texture image corresponding to the inside of the polygon has to be different. First, an attribute region connected to a polygonal vector representing the surface of the facility is set (701) so that the texture can be stored. Like the storing of the general image, the image is divided into a storable area and a non-storable area using the squares (702). For this purpose, the resolution of the texture image and the geographic information of the polygonal vector are used.

Then, in the same manner as the general image storing method, the area that can be stored in the square form stores the color information assigned to each pixel according to the arrangement order of the square (704, 705).

The non-square area stores is defined in a polygonal form and stores the shape and position (705), and the color information to fill the inside is separately stored as the attribute (706, 707). In this manner, all the texture information of complex polygonal shapes can be stored.

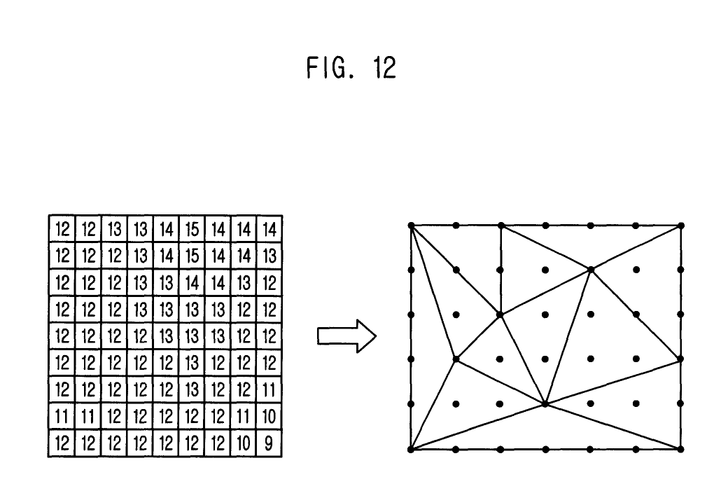

Also, the DEM that records the 3D point such as the point clouds is altitude information of regular grid shape representing topography in number. Therefore, the method of storing the DEM data is similar to the method of storing an image. However, as illustrated in FIG. 12, the DEM information includes a source regular grid information and information given by converting the source regular grid information into a triangulated irregular network (TIN).

Therefore, in order to store the TEM data into vector format, when the TEM data is inputted (308) and the entire area is recorded in a vector format (309). Altitude attribute information with respect to each grid is generated (310). Also, the vector information is generated by converting the DEM into the TIN (311). The vector and the attribute are integrated (317) and the integrated data is stored (318).

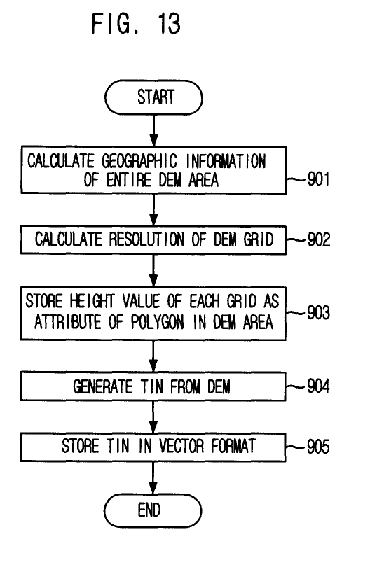

Referring to FIG. 13, a process of dividing the pixel information of the DEM into vector and attribute is carried out. That is, geographic information with respect to the internal rectangular area is extracted from the entire DEM area and stored as vector object (901). Since the internal rectangle is a regular grid shape, only the resolution and height information (altitude information) of each grid is stored as the attribute without vector information (902, 903). This is stored in a vector format (905).

The above-described method of the present invention can be stored in recording media that is implemented in a program and readable by a computer. Examples of the recording medium are CDROM, RAM, ROM, floppy disk, hard disk, optical magnetic disk, and so on. Since the process can be easily carried out by those skilled in the art, a detailed description thereof will be omitted.

While the present invention has been described with respect to certain preferred embodiments, it will be apparent to those skilled in the art that various changes and modifications may be made without departing from the scope of the invention as defined in the following claims.

What is claimed is:

1. A method for storing multipurpose geographic information in a computing system, comprising the steps of:
dividing geographic information data to be stored into minimum units;
classifying the divided geographic information data into geometric information (geographic position information) and attribute information; and
storing the geometric information (geographic position information) in a vector format and storing the attribute information in an attribute information linked to a vector.

2. The method as recited in claim 1, wherein the geographic information data to be stored includes at least one of vector data (numerical map), image data, digital elevation model (DEM), 3D point cloud data, and facility texture information.

3. The method as recited in claim 2, wherein the step of integrating and storing the point cloud data and the vector data includes the steps of:
dividing the inputted point cloud data into point units;
extracting information associated with 3D position among information with respect to each point;
storing the extracted information in a point format among vector object formats;
assigning colors to sections according to altitude and storing the assigned color as an attribute with respect to each point; and
integrating the vector and the attribute and storing the integrated result as an integrated data.

4. The method as recited in claim 2, wherein the step of integrating and storing the image data and the vector data includes the steps of:
extracting geographic information with respect to rectangular area from the entire image, and storing the extracted information as vector object;
storing pixel values of the rectangular area representing each pixel; and
integrating the vector and the attribute and storing the integrated result as an integrated data.

5. The method as recited in claim 2, wherein the step of integrating and storing the facility texture information and the vector data includes the steps of:
dividing polygonal texture and storing color information as an attribute; and
linking the color information to a polygonal vector information and integratedly storing the linked information.

6. The method as recited in claim 2, wherein the step of integrating and storing the facility texture information and the vector data includes the steps of:
setting an attribute area linked to polygonal vector representing a surface of a facility such that the texture is storable;
distinguishing a storable area that is storable using square from a non-storable area that is not storable using square;
storing color information assigned to each pixel according to arrangement order of the square in the storable area;
defining the non-square area as a polygon and storing shape and position of the non-square area, and separately storing color information to fill the interior as an attribute; and
integrating the vector and the attribute and storing the integrated result as the integrated data.

7. The method as recited in claim 6, wherein in the step of distinguishing the areas, resolution of the texture image and geographic information of polygon vector are used.

8. The method as recited in claim 2, wherein the step of integrating and storing the DEM data and the vector data includes the steps of:
extracting geographic information with respect to the internal rectangular area from the entire DEM area and storing the extracted information as vector object;
storing only the resolution and height information (altitude information) of each grid as the attribute without vector information since the internal rectangle is a regular grid shape;
generating a triangulated irregular network (TIN) from the DEM so as to combine DEM data with another vector information;
storing the TIN in a vector format; and
integrating the vector and the attribute and storing the integrated result as the integrated data.
